(19) United States
(12) Patent Application Publication
(10) Pub. No.: US 2015/0263990 A1
(43) Pub. Date: Sep. 17, 2015

(54) NETWORK DEVICE, CONTROL METHOD, AND PROGRAM

(71) Applicant: NEC CORPORATION, Tokyo (JP)

(72) Inventors: Makoto Inoue, Tokyo (JP); Hiroyuki Ohkubo, Tokyo (JP)

(73) Assignee: NEC CORPORATION, Tokyo (JP)

(21) Appl. No.: 14/438,122

(22) PCT Filed: Jul. 12, 2013
(86) PCT No.: PCT/JP2013/069126

§ 371 Date: Apr. 23, 2015

(30) Foreign Application Priority Data
Oct. 24, 2012 (JP) 2012-234328

(51) Int. Cl. H04L 12/911; H04L 29/08

(52) U.S. Cl. CPC H04L 47/827; H04L 67/1097

(57) ABSTRACT

A network device (2000) handles plural physical ports (3000) as a single logical port (4000) by link aggregation. A reception unit (2020) receives a frame. An allocation information storage unit (2040) stores allocation information. A line determination unit (2060) obtains a physical port ID from the allocation information indicating the key information corresponding to the key information relating to the received frame, our of the allocation information stored in the allocation information storage unit (2040). A transmission unit (2080) transmits the frame using the physical port (3000) identified by the physical port ID obtained by the line determination unit (2060).

### TECHNICAL FIELD

The present invention relates to a network device, a control method, and a program.

### BACKGROUND ART

A technique called link aggregation that forms a single logical port by plural physical ports that connect network devices has been proposed. Here, the network device refers to a device being capable of communicating with another network device through a network. For example, the network device includes a network switch, a personal computer (PC), a server, or the like.

The link aggregation bundles the plural physical ports into the single logical port, so that plural transmission paths that connect the network devices appears to be a single transmission path. Thus, the link aggregation can enlarge a bandwidth of the transmission paths between the plural network devices. Further, even when a failure occurs in any one of the plural physical ports that form the single logical port, the communication between the network devices can be continuously performed using the remaining physical ports where the failure has not occurred.

A network device that performs the link aggregation allocates plural pieces of data to be transmitted to another network device through a single logical port formed by the link aggregation to the plural physical ports that form the logical port. Hereinafter, the data to be transmitted from the network device is denoted as a frame. Here, the single logical port formed by the link aggregation is referred to as a link aggregation group (LAG) port. Further, each physical port that forms the LAG port is referred to as a LAG member port. The network device that performs the link aggregation allocates each frame to be transmitted through the LAG port to the LAG member port. Then, each frame is output through the LAG member port.

In the related art, the network device that performs the link aggregation determines the LAG member port that performs the frame output using hash allocation. The hash allocation refers to a method for determining the LAG member port that outputs the frame by executing a predetermined calculation formula based on key information of the frame to be transmitted.

The key information refers to information relating to the frame. The information relating to the frame includes information relating to a reception process when receiving the frame, information included in the frame, or the like, for example. The information relating to the reception process when receiving the frame includes an ID of the physical port that receives the frame, an ID of a virtual port that receives the frame, or the like, for example. The information included in the frame includes a source MAC address, a destination MAC address, a virtual local area network (VLAN) ID, or the like, for example.

Patent Document 1 discloses a node device capable of performing selection of a fixed path on a packet ring network.

Patent Document 2 discloses a communication system in which plural switch nodes that perform link aggregation are connected, capable of reducing a processing load for performing the link aggregation. Here, as the processing load for performing the link aggregation, a process of extracting a source MAC address, a destination MAC address, a source IP address, or a destination IP address from a frame is disclosed. In this communication system, a transmission port fixedly corresponds to information of a connection that receives a received frame and information of a connection that transmits the frame. The information of the connection includes an MPLS label, or the like, for example.

### RELATED DOCUMENT

### Patent Document

[Patent Document 1] Japanese Unexamined Patent Publication No. 2010-206384

[Patent Document 2] Japanese Unexamined Patent Publication No. 2011-249979

### DISCLOSURE OF THE INVENTION

The present inventors reviewed a technique allowing to reliably perform load distribution between the plural physical ports that form the single logical port by the link aggregation. Patent Document 1 does not disclose a technique relating to the link aggregation. Further, Patent Document 2 discloses an operation of the system configured by the plural switch nodes, but does not disclose a unit that performs load balancing.

An object of the invention is to provide a network device, a method and a program capable of reliably performing load distribution between plural physical ports that form a single logical port by link aggregation.

According to an aspect of the invention, there is provided a network device that handles a plurality of physical ports as a single logical port by link aggregation, comprising: a reception unit receiving a frame; an allocation information storage unit storing allocation information, the allocation information being information correlating key information with a physical port ID, the physical port ID being an ID of each of the physical ports; a line determination unit obtaining the physical port ID from the allocation information indicating the key information corresponding to key information relating to the frame, out of the allocation information stored in the allocation information storage means; and a transmission unit transmitting the frame using the physical port identified by the physical port ID obtained by the line determination unit.

According to another aspect of the invention, there is provided a program that causes a computer to function as a network device that handles a plurality of physical ports as a single logical port by link aggregation. The program causes the computer to have functions of respective functional components included in the network device provided by the invention.

According to still another aspect of the invention, there is provided a control method executed by a computer that operates as a network device that handles a plurality of physical ports as a single logical port by link aggregation. The method includes: a reception step of receiving a frame; an allocation information storage step of storing allocation information, the allocation information being information correlating key information with a physical port ID, the physical port ID being an ID of each of the physical ports; a line determination step of obtaining the physical port ID from the allocation information indicating the key information corresponding to key information relating to the frame, out of the allocation information stored by the allocation information storage step; and a transmission step of transmitting the frame using the physical port identified by the physical port ID obtained in the line determination step.

According to the invention, it is possible to provide a network device, a method and a program capable of reliably performing load distribution between plural physical ports that form a single logical port by link aggregation.

### BRIEF DESCRIPTION OF THE DRAWINGS

The above objects and other objects, features and advantages will become apparent by preferred exemplary embodiments to be described below and the accompanying drawings.

FIG. 1 is a block diagram illustrating a network device according to Exemplary Embodiment 1.

FIG. 2 is a diagram illustrating a configuration of an allocation information table.

FIG. 3 is a block diagram illustrating an example of a hardware configuration of the network device according to Exemplary Embodiment 1.

FIG. 4 is a flowchart illustrating an example of the flow of an operation of a network device.

FIG. 5 is a diagram illustrating a network device according to Example 1.

FIG. 6 is a diagram illustrating an example of the network device according to Example 1 in a situation where a line failure occurs.

FIG. 7 is a diagram illustrating another example of the network device according to Example 1 in a situation where a line failure occurs.

FIG. 8 is a diagram illustrating an example of information included in an Ethernet (registered trademark) frame.

FIG. 9 is a diagram illustrating an example of allocation information according to Exemplary Embodiment 2.

FIG. 10 is a diagram illustrating another example of allocation information according to Exemplary Embodiment 2.

FIG. 11 is a diagram illustrating a network device according to Example 2.

FIG. 12 is a diagram illustrating an example of allocation information according to Example 2.

FIG. 13 is a diagram illustrating another example of allocation information according to Example 2.

FIG. 14 is a block diagram illustrating a network device according to Exemplary Embodiment 3.

### DESCRIPTION OF EXEMPLARY EMBODIMENTS

Hereinafter, exemplary embodiments of the invention will be described with reference to the accompanying drawings. In all drawings, the same reference numerals are given to the same components, and the description will not be repeated.

### Exemplary Embodiment 1

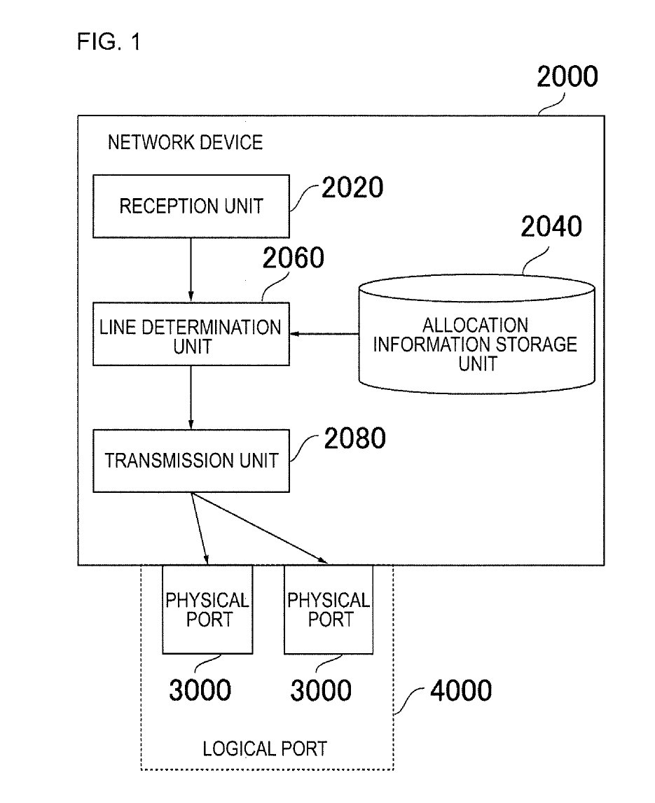

FIG. 1 is a block diagram illustrating a network device 2000 according to Exemplary Embodiment 1. In FIG. 1, the flow of arrows represents the flow of information. Further, in FIG. 1, respective functional components may be configured in a hardware unit, or may be configured in a functional unit.

The network device 2000 handles plural physical ports 3000 as a single logical port 4000 by link aggregation. When transmitting a frame through the logical port 4000, the network device 2000 transmits the frame through any physical port 3000 that forms the logical port 4000.

The port refers to a connection unit that connects a communication line to the network device 2000. The physical port 3000 may be a port that connects a wired line, or may be a port that connects a wireless line. Further, the port may refer to a communication line. In this case, the link aggregation refers to a technique that handles plural physical lines as a single logical line. In this case, the physical port 3000 may be a wired line, or may be a wireless line.

The network device 2000 includes a reception unit 2020. The reception unit 2020 receives a frame. The frame refers to data that flows on a network, such as an Ethernet (registered trademark) frame or an IP packet.

The network device 2000 includes an allocation information storage unit 2040. The allocation information storage unit 2040 stores allocation information. The allocation information refers to information for determining, when the network device 2000 transmits a certain frame, the physical port 3000 to be used for transmission of the frame. Specifically, the allocation information is information correlating key information with a physical port ID of each of the physical ports 3000.

The key information refers to information relating to the frame. The information relating to the frame includes information relating to a reception process when receiving the frame, information included in the frame, or the like, for example. The information relating to the reception process when receiving the frame includes an ID of a physical port that receives the frame, an ID of a virtual port that receives the frame, or the like, for example. The information included in the frame includes a source MAC address, a destination MAC address, a virtual local area network (VLAN) ID, or the like, for example. Further, the key information may be a combination of the above-described variety of information.

The network device 2000 includes a line determination unit 2060. The line determination unit 2060 obtains a physical port ID from the allocation information in which the key information indicated by the allocation information corresponds to key information relating to the received frame, out of the allocation information stored in the allocation information storage unit 2040.

Here, when the key information relating to the frame and the key information indicated by the allocation information match each other, the line determination unit 2060 determines that the key information relating to the frame corresponds to the key information indicated by the allocation information.

In addition, for example, when the key information relating to the frame is included in the key information indicated by the allocation information, the line determination unit 2060 determines that the key information relating to the frame corresponds to the key information indicated by the allocation information. For example, it is assumed that the allocation information includes key information of “reception port IDs 1 to 10”. In this case, if the reception port ID indicated by the key information relating to the frame is any one of 1 to 10, the line determination unit 2060 determines that the key information relating to the frame corresponds to the key information indicated by the allocation information.

The network device 2000 includes a transmission unit 2080. The transmission unit 2080 transmits the frame using the physical port 3000 identified by the physical port ID obtained by the line determination unit 2060.

<Configuration of Allocation Information>

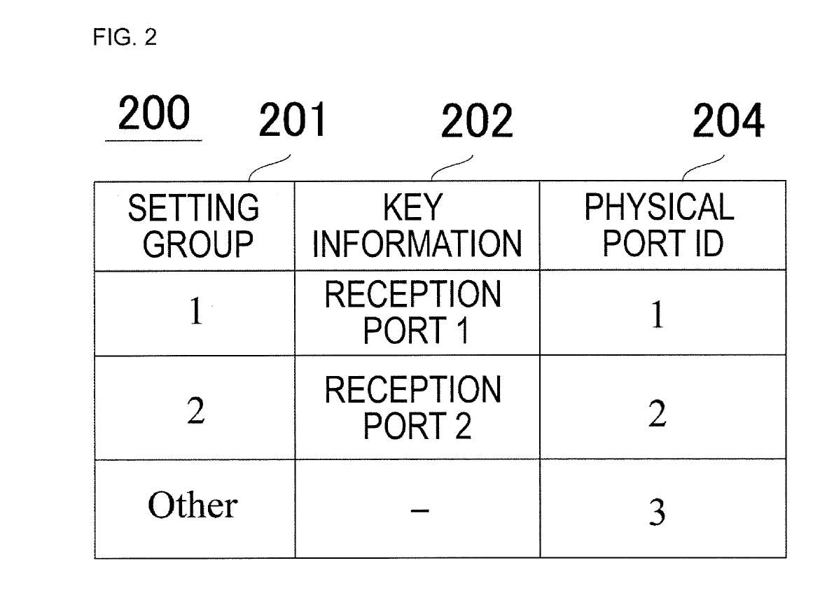

The allocation information includes an allocation information table 200 shown in FIG. 2, for example. The allocation information table 200 includes a setting group 201, key information 202, and a physical port ID 204. In the allocation information table 200, key information indicated by the key information 202 and an ID of the physical port 3000 indicated by the physical port ID 204 are correlated with each other. The setting group 201 is an ID assigned to a combination of the key information 202 and the physical port ID 204.

Here, a record 3 in which the setting group 201 is “other” represents a record for correlating key information that is not indicated by the other records with a physical port ID.

<Hardware Configuration>

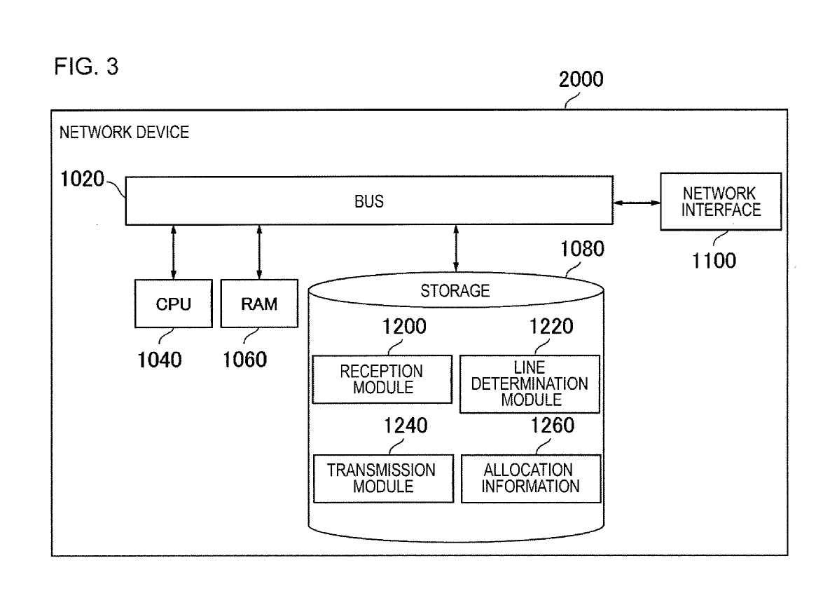

FIG. 3 is a block diagram illustrating an example of a hardware configuration of the network device 2000 according to Exemplary Embodiment 1. In FIG. 3, the network device 2000 includes a bus 1020, a CPU 1040, a RAM 1060, a storage 1080, and a network interface 1100.

The bus 1020 is a transmission path for transmission or reception of information between the respective types of hardware of the CPU 1040, the RAM 1060, the storage 1080, and the network interface 1100.

The network interface 1100 is a network interface that includes the physical port 3000. The network interface 1100 may be a network interface that connects a wireless line, or may be a network interface that connects a wired line.

The CPU 1040 executes a line determination module 1220 that realizes the line determination unit 2060 to realize the function of the line determination unit 2060.

The CPU 1040 executes a reception module 1200 and controls the network interface 1100 to realize the function of the reception unit 2020. Here, when the network interface 1100 has a function of executing a program, the reception module 1200 may be executed by the network interface 1100. Further, the reception module 1200 may be stored inside the network interface 1100.

The CPU 1040 executes a transmission module 1240 and controls the network interface 1100 to realize the function of the transmission unit 2080. Here, when the network interface 1100 has the function of executing the program, the transmission module 1240 may be executed by the network interface 1100. Further, the transmission module 1240 may be stored inside the network interface 1100.

The storage 1080 stores allocation information 1260 to realize the function of the allocation information storage unit 2040. The allocation information 1260 may be stored in the RAM 1060. In this case, the RAM 1060 realizes the function of the allocation information storage unit 2040. Further, when the network device 2000 includes a ROM, the allocation information 1260 may be stored in the ROM. In this case, the ROM realizes the function of the allocation information storage unit 2040.

The reception module 1200, the line determination module 1220, and the transmission module 1240 are stored in the storage 1080, for example. Further, the reception module 1200, the line determination module 1220, and the transmission module 1240 are read to the RAM 1060 by the CPU 1040, for example. Here, the reception module 1200, the line determination module 1220, and the transmission module 1240 may be stored in the RAM 1060. Further, when the network device 2000 includes the ROM, the reception module 1200, the line determination module 1220, and the transmission module 1240 may be stored in the ROM.

The storage 1080 is a storage unit such as a hard disk, a USB memory or a solid state drive (SSD). Further, the storage 1080 may be a storage device such as a RAM or a ROM.

<Flow of Operation>

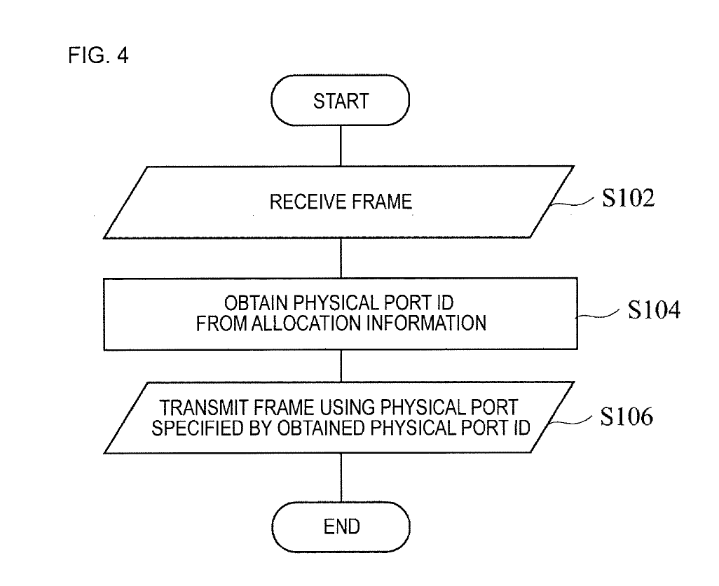

FIG. 4 is a flowchart illustrating an example of the flow of an operation of the network device 2000.

In step S102, the reception unit 2020 receives a frame.

In step S104, the line determination unit 2060 obtains a physical port ID from the allocation information stored in the allocation information storage unit 2040. Specifically, the line determination unit 2060 obtains the physical port ID from the allocation information in which key information indicated by the allocation information corresponds to key information relating to the received frame, out of the allocation information stored in the allocation information storage unit 2040.

In step S106, the transmission unit 2080 transmits the frame using the physical port 3000 identified by the physical port ID obtained by the line determination unit 2060.

<Effects>

In the network device 2000, the physical port 3000 used for transmission of the frame is fixedly set in correlation with the key information relating to the frame by the allocation information. Accordingly, it is possible to fixedly determine which physical port 3000 each frame is output from, in the network device 2000. Thus, when it is recognized which frame is received by the network device 2000, by setting the allocation information based on the recognized information, it is possible to reliably distribute the load of the physical port 3000 due to the frame transmission.

Further, by the setting of the allocation information, it is possible to realize the network device 2000 having a redundant configuration. For example, the plural physical ports 3000 are divided into the physical ports 3000 of an operational system and the physical ports 3000 of a preparatory system. As a specific example, when the number of the physical ports 3000 is three, two physical ports 3000, as the operational system, are normally used, and the remaining one physical port 3000, as the preparatory system, is not normally used.

Further, when the physical port 3000 of the operational system cannot perform communication due to a line failure or the like, an ID of the physical port 3000 that cannot perform the communication is changed to an ID of the physical port 3000 of the preparatory system in the allocation information. According to this configuration, it is possible to continue the frame transmission using the physical port 3000 of the preparatory system. The physical port 3000 to be switched to when the failure occurs may be set in advance, or may be set when the failure occurs.

Here, when the physical port 3000 of the operational system in which a line failure occurs is switched to the physical port 3000 of the preparatory system, one physical port 3000 of the preparatory system may be used, or the plural physical ports 3000 of the preparatory system may be used. When the plural physical ports 3000 of the preparatory system are used, the communication load applied to the physical port 3000 of the operational system that cannot perform the communication can be distributed to the plural physical ports 3000 of the preparatory system. In this way, by performing the distribution exchange for distributing the frame to the plural physical ports 3000 of the preparatory system, it is possible to smooth the load applied to the physical ports 3000 of the preparatory system.

Further, by fixedly setting the physical port 3000 that transmits the frame by the allocation information, even when a line failure occurs, it is possible to guarantee that the transmission path of the frame using the physical port 3000 where a line failure does not occur is not changed. Here, in the case of the hash allocation that is the related art allocation method, if the number of the physical ports 3000 is reduced when a line failure occurs, a hash is re-calculated to perform re-allocation of the physical ports 3000 for transmission. Thus, with respect to the frame transmitted through the physical port 3000 where a line failure does not occur, the physical port 3000 for transmission may be changed.

On the other hand, in the network device 2000 according to Exemplary Embodiment 1, since the transmission destination of the frame is fixedly allocated, it is possible to guarantee that frames having the same key information are constantly transmitted through the same physical port 3000. Accordingly, even when a line failure occurs, the frame transmitted using the physical port 3000 where a line failure has not occurred is continuously transmitted using the same physical port 3000.

### Example 1

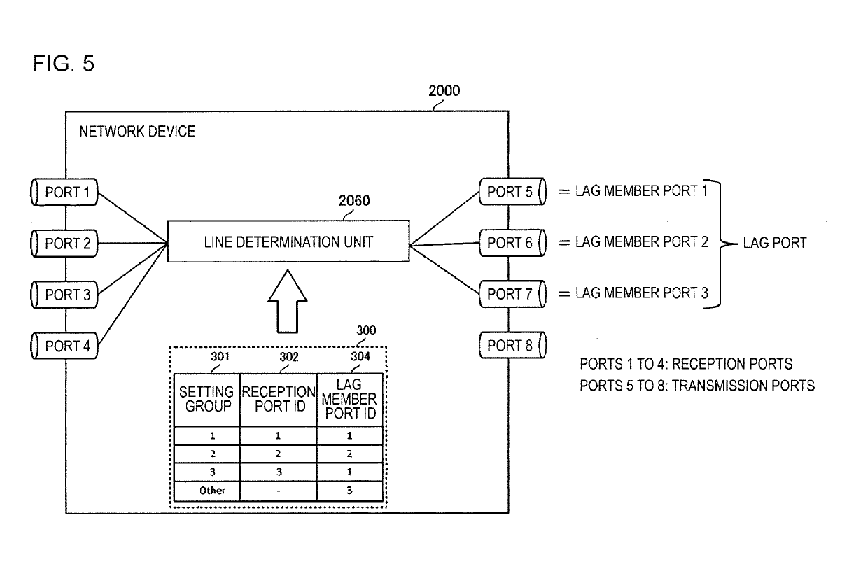

Hereinafter, a specific example of the network device 2000 according to Exemplary Embodiment 1 will be described as Example 1. FIG. 5 is a diagram schematically illustrating a configuration and an operation of the network device 2000 according to Example 1. Here, in FIG. 5, the reception unit 2020, the allocation information storage unit 2040, and the transmission unit 2080 are not shown.

The network device 2000 of Example 1 uses an ID (reception port ID) of a physical port that receives a frame, as key information. Here, as described above, the information that is usable by the network device 2000 according to Exemplary Embodiment 1 as the key information is not limited to the reception port ID.

Further, the network device 2000 of Example 1 handles an Ethernet (registered trademark) frame as the frame. Here, as described above, the data that is handled by the network device 2000 of Example 1 as the frame is not limited to the Ethernet (registered trademark) frame.

As shown in FIG. 5, the network device 2000 of Example 1 includes eight physical ports (ports 1 to 8). Ports 1 to 4 are reception ports, and ports 5 to 8 are transmission ports.

The network device 2000 forms a single logical port using three transmission ports of ports 5 to 7 by link aggregation. Hereinafter, this logical port is referred to as a LAG port. Further, ports 5 to 7 that form the LAG port are respectively denoted as LAG member ports 1 to 3.

The network device 2000 uses the allocation information table 300 shown in FIG. 5 as allocation information. The allocation information table 300 includes a setting group 301, a reception port ID 302, and a LAG member port ID 304. The setting group 301 corresponds to the setting group 201 of the allocation information table 200. The reception port ID 302 corresponds to the key information 202 of the allocation information table 200. The LAG member port ID 304 corresponds to the physical port ID 204 of the allocation information table 200.

The allocation information table 300 includes four records. Each record 1, 2 or 3 of the setting group 301 is correlated with an ID of a reception port indicated by the reception port ID 302 and a LAG member port ID indicated by the LAG member port ID 304. A record “other” of the setting group 301 represents a LAG member port ID that is selected when an ID of a reception port that receives a frame does not match any ID of the reception port ID 302 indicated by the record 1, 2 or 3 of the setting group.

When the frame is received, the network device 2000 first determines whether an output destination of the received frame is a LAG port or not. Further, when the output destination of the received frame is the LAG port, the line determination unit 2060 determines a LAG member port to be used for frame transmission using the allocation information. When information included in the frame is used as key information, the network device 2000 further performs an analysis process of analyzing the content of the frame to extract the key information included in the frame.

The network device 2000 reads the allocation information table 300 using the ID of the reception port that receives the frame, and determines the LAG member port that transmits the frame. For example, the network device 2000 transmits the frame received by port 1 using LAG member port 1 (port 5). Further, for example, the network device 2000 transmits the frame received by port 2 using LAG member port 2 (port 6).

Here, there is no record that indicates port 4 as the reception port ID 302 in the allocation information table 300. Thus, the network device 2000 transmits the frame received by port 4 using LAG member port 3 (port 7) indicated by the record “other” of the setting group 301.

Here, it is assumed that the allocation information can be freely set using a command line interface (CLI) or a graphical user interface (GUI) from a maintenance terminal connected to the network device 2000, for example. For example, a manager of the network device 2000 or a user of the network device 2000 performs this setting. The allocation information may be set before operation of the network device 2000, or may be appropriately added or changed in the setting after the operation is started.

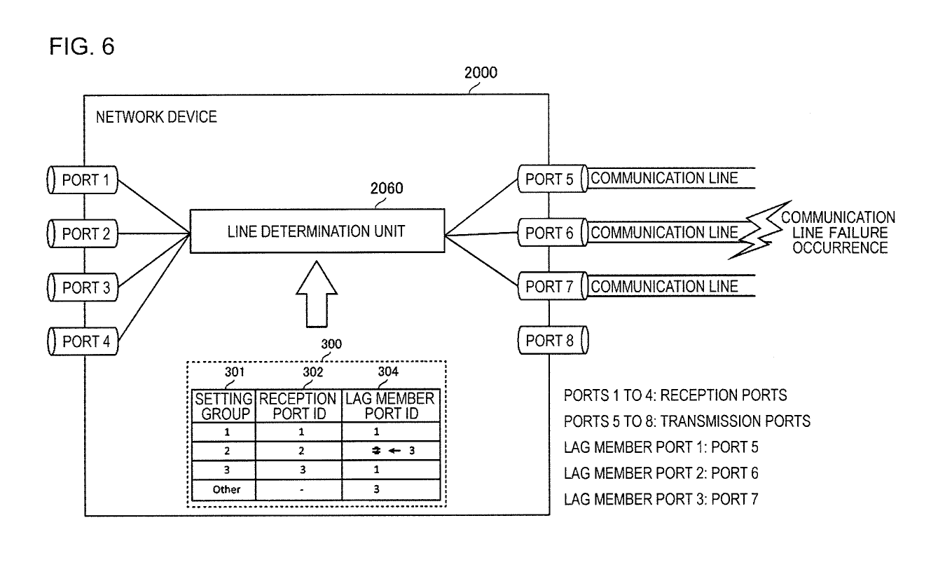

Further, when any LAG member port cannot be used due to a line failure or the like, the network device 2000 can continue the frame transmission by changing the allocation information table 300. For example, as shown in FIG. 6, it is assumed that port 6 (LAG member port 2) cannot be used due to a line failure. In this case, the LAG member port ID 304 indicated by the record 2 of the allocation information table 300 is changed to 3, for example. Accordingly, the network device 2000 transmits the frame received through port 2 using LAG member port 3 where a line failure has not occurred. Thus, in the network device 2000, the transmission of the frame received through port 2 is continued.

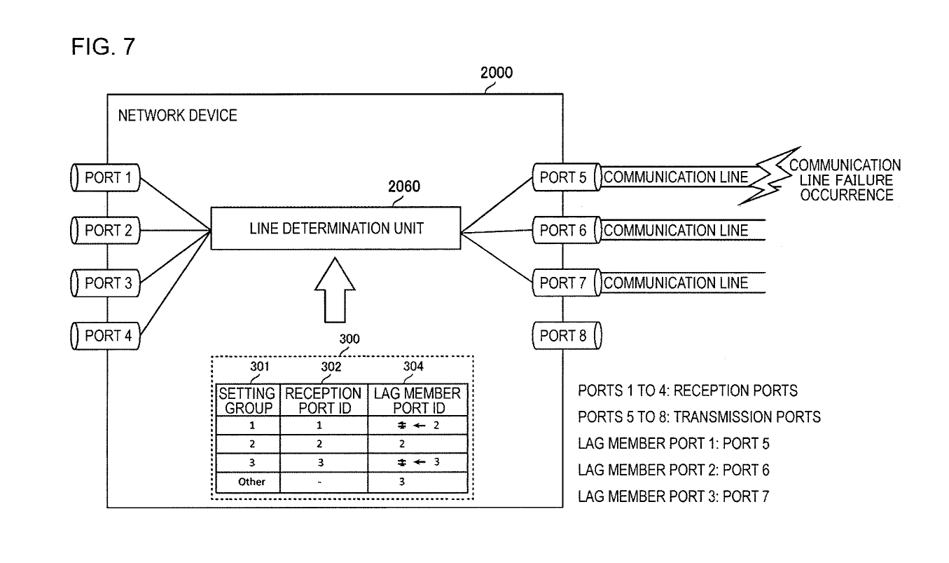

In addition, when the LAG member port that is not usable due to a line failure or the like is included in plural setting groups, by replacing the unusable LAG member port with plural LAG member ports, it is possible to distribute the load applied to the replaced LAG member ports. For example, as shown in FIG. 7, it is assumed that LAG member port 1 is not usable due to a line failure or the like. Here, in the allocation information table 300, LAG member port 1 is included in two setting groups 1 and 3.

Thus, for example, the LAG member port correlated with port 1 in the setting group 1 is changed to LAG member port 2, and the LAG member port correlated with port 3 in the setting group 3 is changed to LAG member port 3. Accordingly, the network device 2000 transmits the frame transmitted using LAG member port 1 to be shared by LAG member port 2 and LAG member port 3. Thus, in the network device 2000, it is possible to distribute the load between the LAG member ports used instead of LAG member port 1 that is not usable while continuing the transmission of the frame received through port 1 and port 3.

### Exemplary Embodiment 2

A network device 2000 according to Exemplary Embodiment 2 is the same as the network device 2000 according to Exemplary Embodiment 1, which is shown in FIG. 1.

Hereinafter, unless there is particular description, the respective functional components included in the network device 2000 according to Exemplary Embodiment 2 have the same functions as in the network device 2000 according to Exemplary Embodiment 1.

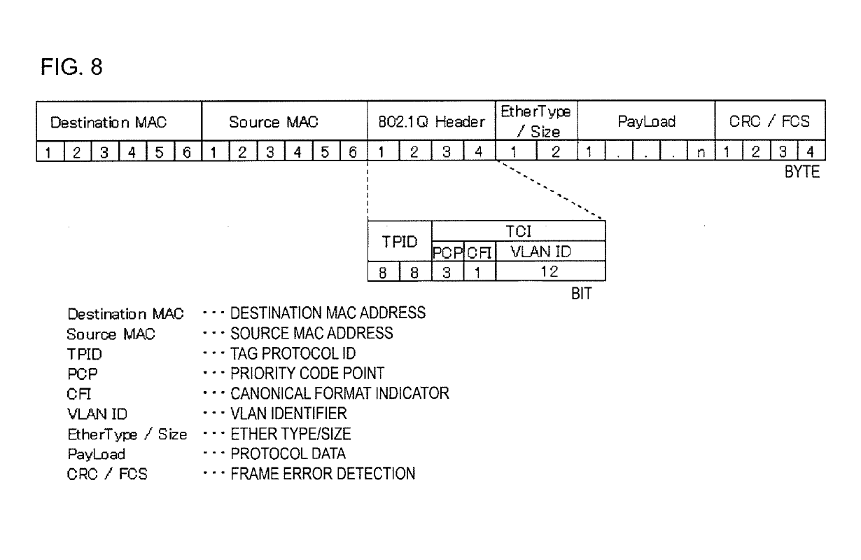

A reception unit 2020 according to Exemplary Embodiment 2 receives a frame that is assigned key information. The key information included in the frame is information such as a layer-2 address that is represented by a VLAN ID and a MAC address or a layer-3 address that is represented by an IP address, for example. Further, the key information may be a combination of one or more of the pieces of information described above. For example, information as shown in FIG. 8 is included in an Ethernet (registered trademark) frame.

In Exemplary Embodiment 2, key information relating to a frame includes the key information included in the frame.

<Specific Example of Allocation Information>

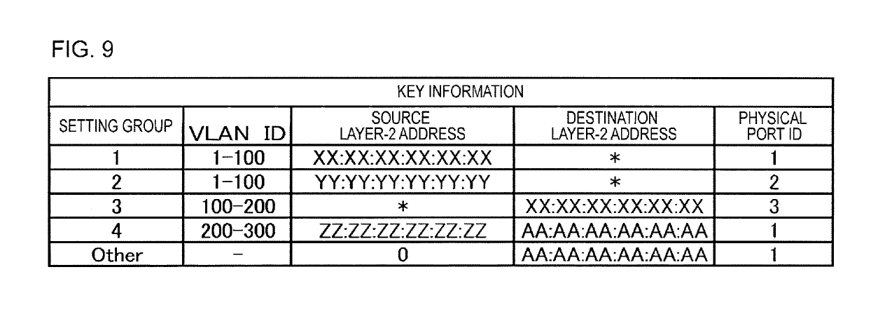

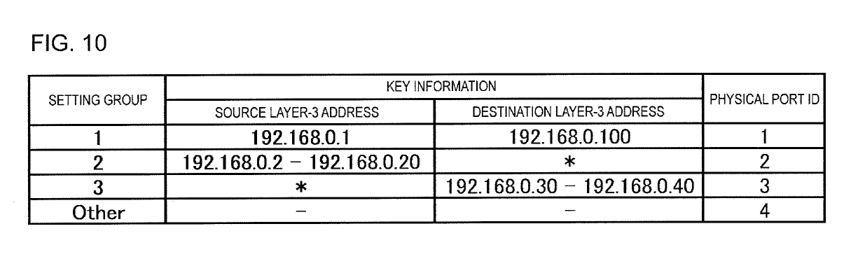

Allocation information in Exemplary Embodiment 2 is shown in FIG. 9 or FIG. 10, for example. The allocation information shown in FIG. 9 is allocation information that represents a combination of “VLAN ID, source layer-2 address and destination layer-2 address” as the key information. The allocation information shown in FIG. 10 is allocation information that represents a combination of “source layer-3 address and destination layer-3 address” as the key information. Here, in FIG. 9 or FIG. 10, a mark * represents a wild card that represents an arbitrary value. For example, a record 1 in FIG. 9 represents key information in which “the VLAN ID is any one of 1 to 100, the source layer-2 address is XX:XX:XX:XX:XX:XX, and the destination layer-2 address is arbitrary”.

In addition, the key information according to the present exemplary embodiment may include information that is not assigned to the frame, such as a reception port ID shown in Exemplary Embodiment 1 as an example. In this case, the key information is a combination of “reception port ID and source layer-2 address”, for example.

<Effects>

As described above, according to the present exemplary embodiment, the physical port 3000 used for transmission of the frame is determined based on the variety of information included in the frame. In general, a variety of information such as a VLAN ID and a layer-2 address is included in a frame. Thus, according to the present exemplary embodiment, the correlation between the frame and the physical port 3000 used for transmission of the frame can be flexibly set.

### Example 2

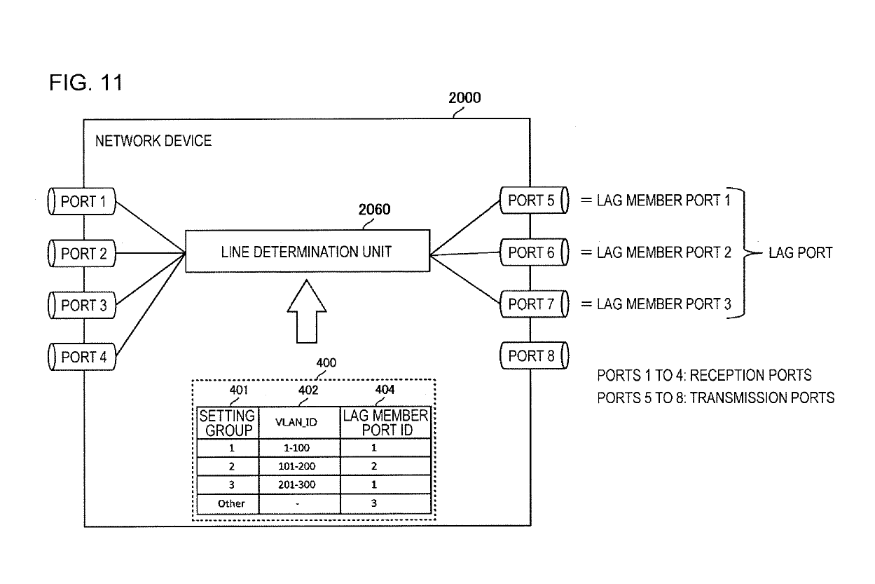

Hereinafter, a method for specifically using the network device 2000 according to Exemplary Embodiment 2 will be described as Example 2. FIG. 11 is a diagram illustrating the network device 2000 of Example 2. In the network device 2000 of Example 2, configurations and operations that are not particularly described are the same as in the network device 2000 of Example 1.

The network device 2000 of Example 2 uses a VLAN ID included in a frame as key information. Here, the key information included in the frame is not limited to the VLAN ID, as described above. The network device 2000 of Example 2 performs an analysis process of analyzing the received frame to extract the key information from the frame.

The network device 2000 uses an allocation information table 400 shown in FIG. 11 as allocation information. The allocation information table 400 includes a setting group 401, a VLAN_ID 402, and a LAG member port 404. The setting group 401 corresponds to the setting group 201 of the allocation information table 200. The VLAN_ID 402 corresponds to the key information 202 of the allocation information table 200. LAG member port 404 corresponds to the physical port 204 of the allocation information table 200.

In the allocation information table 400, the VLAN_ID 402 represents a range of VLAN IDs correlated with a LAG member port indicated by LAG member port 404. For example, in the allocation information table 400, a record 1 of the setting group 401 correlates VLAN IDs of 1 to 100 with LAG member port 1.

The line determination unit 2060 of the network device 2000 reads the allocation information table 400 using a VLAN ID included in the received frame to determine a LAG member port that transmits the frame. For example, the network device 2000 transmits a frame of which the VLAN ID is 50 using LAG member port 1. Further, the network device 2000 transmits a frame of which the VLAN ID is 110 using LAG member port 2.

Here, in the allocation information table 400, there is no record that represents a VLAN ID greater than 300 in the VLAN_ID 402. Thus, the network device 2000 transmits a frame having a VLAN ID greater than 300 using LAG member port 3 indicated by a record “other” of the setting group 401.

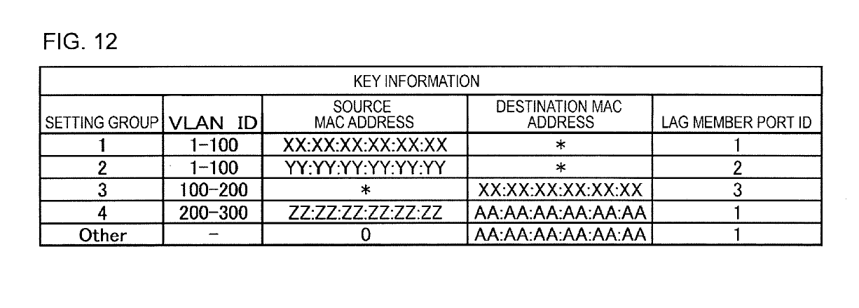

In addition, for example, as shown in FIG. 12, the network device 2000 of Example 2 uses allocation information that correlates key information indicated by a combination of “VLAN ID, source MAC address, and destination MAC address” with a LAG member port ID. Here, in FIG. 12, a mark * represents a wild card that represents an arbitrary value.

For example, a record 1 of the allocation information shown in FIG. 12 represents that key information in which “the VLAN ID is any one of 1 to 100, the source MAC address is XX:XX:XX:XX:XX:XX, and the destination MAC address is arbitrary” is transmitted using LAG member port 1.

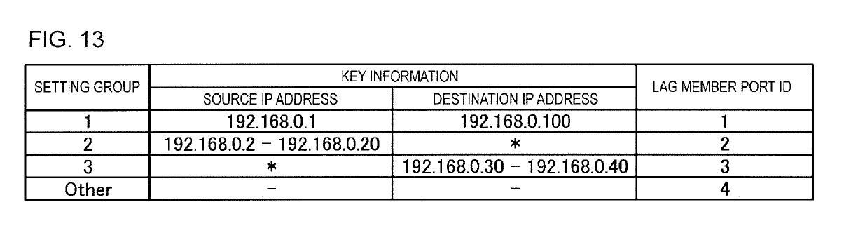

In addition, for example, as shown in FIG. 13, the network device 2000 of Example 2 uses allocation information that correlates key information indicated by a combination of “source IP address and destination IP address” with a LAG member port ID.

### Exemplary Embodiment 3

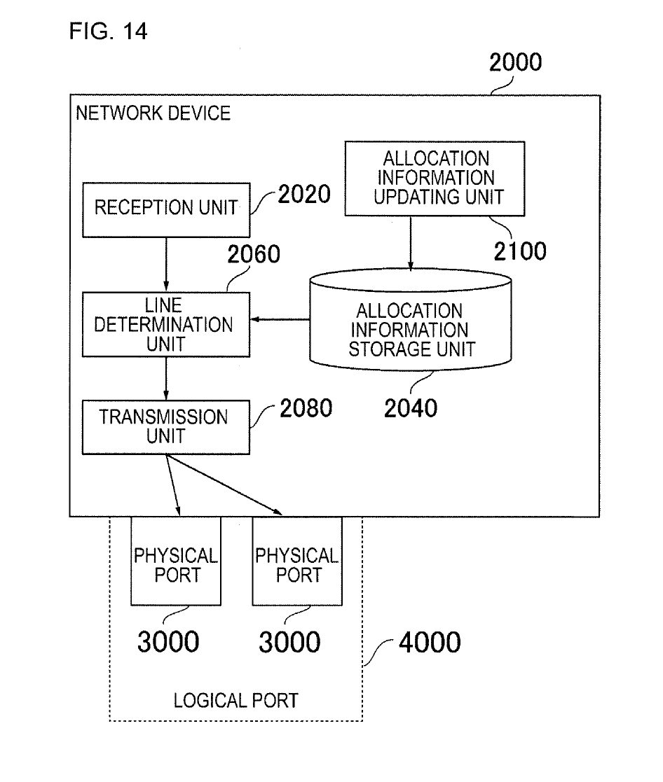

FIG. 14 is a block diagram illustrating a network device 2000 according to Exemplary Embodiment 3. Functional components having the same reference numerals as in FIG. 1, among functional components shown in FIG. 14, have the same functions as those of the functional components shown in FIG. 1. Further, in FIG. 14, each functional component may be configured in a hardware unit, or may be configured in a functional unit.

The network device 2000 according to Exemplary Embodiment 3 further includes an allocation information updating unit 2100. The allocation information updating unit 2100 updates information stored in the allocation information storage unit 2040.

For example, the allocation information updating unit 2100 obtains new allocation information. Further, the allocation information updating unit 2100 overwrites allocation information indicating the same key information as in the obtained allocation information, out of the allocation information stored in the allocation information storage unit 2040, with the obtained allocation information. For example, it is assumed that the allocation information table 200 shown in FIG. 2 is stored in the allocation information storage unit 2040. Further, it is assumed that the allocation information updating unit 2100 obtains allocation information indicating a correlation of “key information 202=reception port 2, physical port ID 204=4”. In this case, the allocation information updating unit 2100 changes the physical port ID 204 indicated by the record shown in FIG. 2 from 2 to 4.

Further, for example, when there is no allocation information indicating the same key information as in the obtained allocation information, in the allocation information stored in the allocation information storage unit 2040, the allocation information storage unit 2040 newly registers the obtained allocation information. For example, it is assumed that the allocation information table 200 shown in FIG. 2 is stored in the allocation information storage unit 2040. Further, it is assumed that the allocation information updating unit 2100 obtains allocation information indicating a correlation of “key information 202=reception port 3, physical port ID 204=4”. In this case, the allocation information updating unit 2100 adds a new record of “setting group 201=3, key information 202=reception port 3, physical port ID 204=4” to the allocation information table 200 shown in FIG. 2.

In addition, for example, the allocation information updating unit 2100 receives designation of allocation information to be deleted, and deletes the designated allocation information. For example, it is assumed that the allocation information table 200 shown in FIG. 2 is stored in the allocation information storage unit 2040. In this case, the allocation information updating unit 2100 obtains the setting group ID of the allocation information to be deleted, for example. For example, when the allocation information updating unit 2100 obtains 2 as the setting group ID to be deleted, the network device 2000 deletes the record 2 from the allocation information table 200 shown in FIG. 2.

In addition, for example, the allocation information updating unit 2100 has a function of deleting the entirety of allocation information stored in the allocation information storage unit 2040.

The allocation information updating unit 2100 obtains information for updating the allocation information, such as new allocation information, from a maintenance terminal connected to the network device 2000 through a CLI or a GUI, for example. In addition, for example, the network device 2000 may include an input unit such as a keyboard. In this case, the allocation information updating unit 2100 obtains the information for updating the allocation information through the input unit.

<Effects>

According to such a configuration, the network device 2000 according to Exemplary Embodiment 3 can update the allocation information. Thus, the allocation information stored in the network device 2000 can be updated according to a change of traffic received by the network device 2000, for example. Accordingly, the network device 2000 according to Exemplary Embodiment 3 can reliably perform the load distribution between the physical ports 3000, compared with a case where the allocation information cannot be changed.

Hereinbefore, the exemplary embodiments and examples of the invention are described with reference to the drawings, but these exemplary embodiments and examples are only examples of the invention, and a combination of the above-described exemplary embodiments or examples and various configurations other than the above-described exemplary embodiments or examples may be employed.

Hereinafter, examples of reference exemplary embodiments will be additionally described.

1. A network device that handles plural physical ports as a single logical port by link aggregation, including: a reception unit receiving a frame; an allocation information storage unit storing allocation information, the allocation information being information correlating key information with a physical port ID, the physical port ID being an ID of each of the physical ports; a line determination unit obtaining the physical port ID from the allocation information indicating the key information corresponding to key information relating to the frame, out of the allocation information stored in the allocation information storage means; and a transmission unit transmitting the frame using the physical port identified by the physical port ID obtained by the line determination unit.

2. The network device according to 1, in which the reception unit receiving a frame to which the key information is assigned, and the key information relating to the frame includes the key information included in the frame.

3. The network device according to 1 or 2, further including: an allocation information updating unit updating the allocation information stored in the allocation information storage unit.

4. A program that causes a computer to function as a network device that handles plural physical ports as a single logical port by link aggregation, the program causing the computer to execute: a reception function of receiving a frame; an allocation information storage function of storing allocation information, the allocation information being information correlating key information with a physical port ID, the physical port ID being an ID of each of the physical ports; a line determination function of obtaining the physical port ID from the allocation information indicating the key information corresponding to key information relating to the frame, out of the allocation information stored by the allocation information storage function; and a transmission function of transmitting the frame using the physical port identified by the physical port ID obtained by the line determination function.

5. The program according to 4, in which the reception function receives a frame to which the key information is assigned, and the key information relating to the frame includes the key information included in the frame.

6. The program according to 4 or 5, the computer further including: an allocation information updating function of updating the allocation information stored by the allocation information storage function.

7. A control method executed by a computer that operates as a network device that handles plural physical ports as a single logical port by link aggregation, the method including: a reception step of receiving a frame; an allocation information storage step of storing allocation information, the allocation information being information correlating key information with a physical port ID, the physical port ID being an ID of each of the physical ports; a line determination step of obtaining the physical port ID from the allocation information indicating the key information corresponding to key information relating to the frame, out of the allocation information stored by the allocation information storage step; and a transmission step of transmitting the frame using the physical port identified by the physical port ID obtained in the line determination step.

8. The control method according to 7, in which the reception step receives a frame to which the key information assigned, and the key information relating to the frame includes the key information included in the frame.

9. The control method according to 7 or 8, further including: an allocation information updating step of updating the allocation information stored by the allocation information storage step.

This application is based on and claims the priority of Japanese Patent Application No. 2012-234328 filed on Oct. 24, 2012, the entire contents of which are incorporated herein by reference.

1. A network device that handles a plurality of physical ports as a single logical port by link aggregation, comprising:
a reception unit receiving a frame;
an allocation information storage unit storing allocation information, the allocation information being information correlating key information with a physical port ID, the physical port ID being an ID of each of the physical ports;
a line determination unit obtaining the physical port ID from the allocation information indicating the key information corresponding to key information relating to the frame, out of the allocation information stored in the allocation information storage means; and
a transmission unit transmitting the frame using the physical port identified by the physical port ID obtained by the line determination unit.

2. The network device according to claim 1, wherein
the reception unit receiving a frame to which the key information is assigned, and
the key information relating to the frame includes the key information included in the frame.

3. The network device according to claim 1, further comprising:
an allocation information updating unit updating the allocation information stored in the allocation information storage unit.

4. A non-transitory computer-readable storage medium storing a program that causes a computer to function as a network device that handles a plurality of physical ports as a single logical port by link aggregation, the program causing the computer to execute:
a reception function of receiving a frame;
an allocation information storage function of storing allocation information, the allocation information being information correlating key information with a physical port ID, the physical port ID being an ID of each of the physical ports;
a line determination function of obtaining the physical port ID from the allocation information indicating the key information corresponding to key information relating to the frame, out of the allocation information stored by the allocation information storage function; and
a transmission function of transmitting the frame using the physical port identified by the physical port ID obtained by the line determination function.

5. A control method executed by a computer that operates as a network device that handles a plurality of physical ports as a single logical port by link aggregation, the method comprising:
a reception step of receiving a frame;
an allocation information storage step of storing allocation information, the allocation information being information correlating key information with a physical port ID, the physical port ID being an ID of each of the physical ports;
a line determination step of obtaining the physical port ID from the allocation information indicating the key information corresponding to key information relating to the frame, out of the allocation information stored by the allocation information storage step; and
a transmission step of transmitting the frame using the physical port identified by the physical port ID obtained in the line determination step.
